(19) United States
(12) Patent Application Publication
(10) Pub. No.: US 2019/0058850 A1
(43) Pub. Date: Feb. 21, 2019

(54) SECURITY SURVEILLANCE SYSTEMS AND METHODS

(71) Applicant: Reginald Gillis, Leesburg, VA (US)

(72) Inventor: Reginald Gillis, Leesburg, VA (US)

(21) Appl. No.: 16/052,989

(22) Filed: Aug. 2, 2018

Related U.S. Application Data
(60) Provisional application No. 62/546,754, filed on Aug. 17, 2017.

(51) Int. Cl. H04N 7/18; H04N 5/225; H04N 5/77; H04N 7/10

(52) U.S. Cl. CPC H04N 7/181; H04N 5/2253; H04N 7/10; H04N 5/772; H04N 5/2252

(57) ABSTRACT

The disclosure includes a remote surveillance system that can include a stanchion elongate along a vertical direction and a housing coupled to an upper surface of the stanchion. Embodiments of the system can also include a camera located within an internal portion of the housing, wherein the camera is arranged and configured to capture images of people located adjacent to the stanchion.

### CROSS-REFERENCE TO RELATED APPLICATIONS

This application claims the benefit of U.S. Provisional Patent Application No. 62/546,754; filed Aug. 17, 2017; and entitled SECURITY SURVEILLANCE SYSTEMS AND METHODS. The entire contents of U.S. Provisional Patent Application No. 62/546,754 are incorporated herein by reference.

### BACKGROUND

### Field

Various embodiments disclosed herein relate to surveillance systems and methods. Certain embodiments relate to airport security surveillance systems and methods.

### Description of Related Art

Today's airports face constant threats of terrorist attacks and other security concerns. Accordingly, airports maintain some of the highest security in the world. Some airports utilize cameras and other monitoring equipment that are far away from security lines. Because of their location, such cameras can often miss crucial details. Thus, there is a need for surveillance systems that can increase the efficacy and accuracy of detecting security threats in airport security lines

### SUMMARY

The disclosure includes a surveillance system that can include a stanchion elongate along a vertical direction, a housing coupled to an upper surface of the stanchion, and a camera located within an internal portion of the housing. The camera can be arranged and configured to capture images of people located adjacent to the stanchion. The camera can be visually hidden from the people located adjacent to the stanchion.

In some embodiments, the camera comprises a rechargeable camera. Even still, in some embodiments, the system includes a backup battery located within the internal portion of the housing. The backup battery can be configured to provide backup power to the rechargeable camera.

The camera can comprise an IP camera. As such, the system may include a power source configured to provide power to the IP camera. In some embodiments, the system includes a Power over Ethernet (PoE) cable electrically coupled to the camera and the power source.

Even still, in some embodiments, the system includes at least one of a digital video recorder and a network video recorder communicatively coupled to the camera and remotely located with respect to the camera. The at least one of the digital video recorder and the network video recorder can be located within an internal portion of the stanchion.

The system may also include a coaxial closed circuit television Siamese cable electrically coupled to the camera and at least one of the digital video recorder and the network video recorder. The coaxial closed circuit television Siamese cable may be at least partially located within the internal portion of the housing and the internal portion of the stanchion such that the coaxial closed circuit television Siamese cable is substantially hidden from view.

In some embodiments, the system includes a monitoring station communicatively coupled to the camera and at least one of the digital video recorder and the network video recorder. The monitoring station can be arranged and configured to display an image captured by the camera. The monitoring station may be located within the housing.

The external surface of the housing may comprise at least one of glass and mirror. The housing may also be arranged and configured to be vertically and rotatably adjusted with respect to the stanchion.

In some embodiments, the stanchion is referred to a first stanchion, the system may thereby comprise a second stanchion coupled to the first stanchion by a stanchion belt. The housing may also be referred to as a first housing, and the camera as a first camera. The system may thereby include a second stanchion elongate along the vertical direction and coupled to the first stanchion by a stanchion belt, a second housing coupled to an upper surface of the second stanchion, and a second camera located within an internal portion of the second housing. The second camera can be arranged and configured to capture images of people located adjacent to the second stanchion.

Even still, in some embodiments, the system further incudes at least one of a digital video recorder and a network video recorder communicatively coupled to both the first camera and the second camera. The at least one of the digital video recorder and the network video recorder may be located within an internal portion of the first stanchion and remotely located with respect to the second stanchion.

The system may also include a coaxial closed circuit television Siamese cable electrically coupled to the first camera, the second camera, and at least one of the digital video recorder and the network video recorder. The coaxial closed circuit television Siamese cable may be at least partially located within the internal portion of the first housing, the internal portion of the first stanchion, the internal portion of the second housing, an internal portion of the second stanchion, and an internal portion of the stanchion belt such that the coaxial closed circuit television Siamese cable is substantially hidden from view. Even still, in some embodiments, the internal portion of the first stanchion is larger than the internal portion of the second stanchion.

The embodiments described above include many optional features and aspects. Features and aspects of the embodiments can be combined.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a side view of a surveillance system, according to some embodiments.

FIGS. 2 and 3 illustrate diagramatic views of surveillance systems, according to some embodiments.

FIGS. 4 and 5 illustrate side views of surveillance systems, according to some embodiments.

FIG. 6 illustrates a first stanchion and a second stanchion, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Introduction

Airport security checkpoints differ in size, layout, types of obstructive objects (e.g. pillars and columns), and the like. However, a common feature present in all security checkpoints are stanchions, which are used to create queues to route travelers. This disclosure includes a surveillance system that implements a camera and other security and monitoring equipment into stanchions and other equipment used in conjunction with stanchions.

### Surveillance System Embodiments

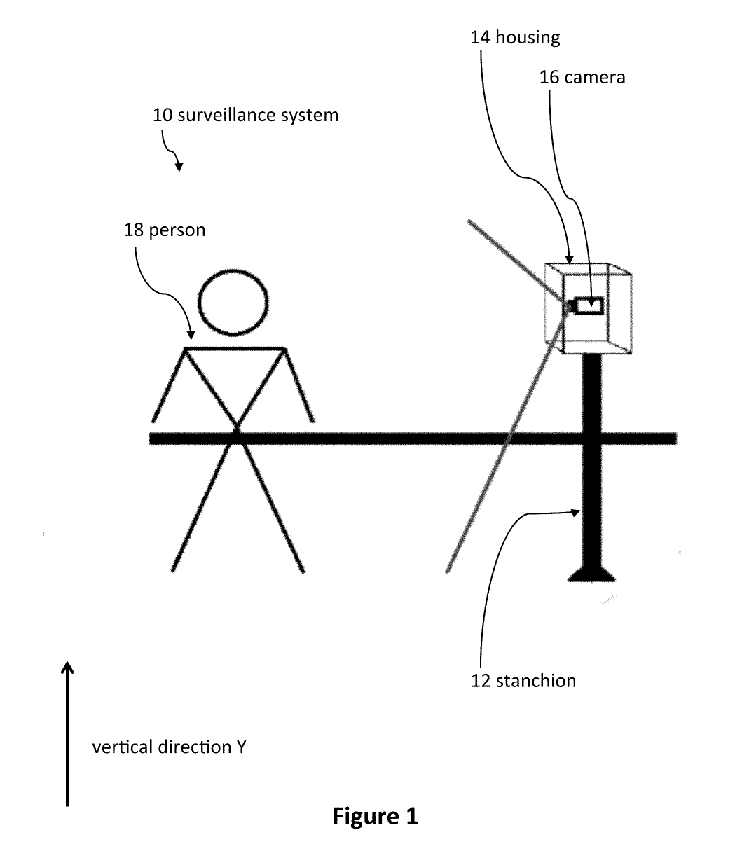

As illustrated in FIG. 1, the disclosure includes a surveillance system 10, comprising a stanchion 12 elongate along a vertical direction Y and a housing 14 coupled to an upper surface of the stanchion 12. The system 10 can also include a camera 16 located within an internal portion of the housing 14. The camera 16 can be arranged and configured to capture images of people 18 located adjacent to the stanchion 12. In some embodiments the camera 16 is visually hidden from the people 18 located adjacent to the stanchion 12. In this manner, the people 18 may have no idea that a camera is present and capturing images.

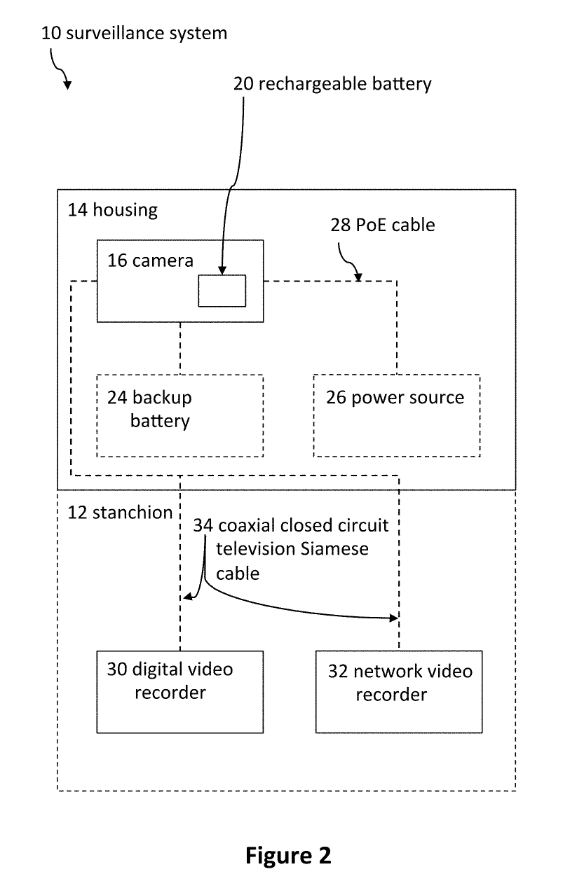

Now with reference to FIG. 2, in some embodiments, the camera 16 comprises a rechargeable camera 20. In order to expand the power supply, the system 10 may even include a backup battery 24 located within the internal portion of the housing 14. The backup battery 24 may be configured to provide backup power to the rechargeable camera 20.

In some embodiments, the camera 16 comprises an IP camera. In such embodiments, the system 10 can further include a power source 26 configured to provide power to the IP camera and a Power over Ethernet cable 28 (PoE cable) electrically coupled to the camera 16 and the power source 26.

With continued reference to FIG. 2, the system 10 can even include at least one of a digital video recorder 30 and a network video recorder 32 communicatively coupled to the camera 16 and remotely located with respect to the camera 16. The digital video recorder 30 and/or the network video recorder 32 can be located within an internal portion of the stanchion 12. In this manner, the digital video recorder 30 and/or the network video recorder 32 can be hidden from view.

The digital video recorder 30, the network video recorder 32, and/or the camera 16 can be electrically coupled together via a coaxial closed circuit television Siamese cable 34. The coaxial closed circuit television Siamese cable 34 may be at least partially located within the internal portion of the housing 14 and the internal portion of the stanchion 12 such that the coaxial closed circuit television Siamese cable 34 is substantially hidden from view.

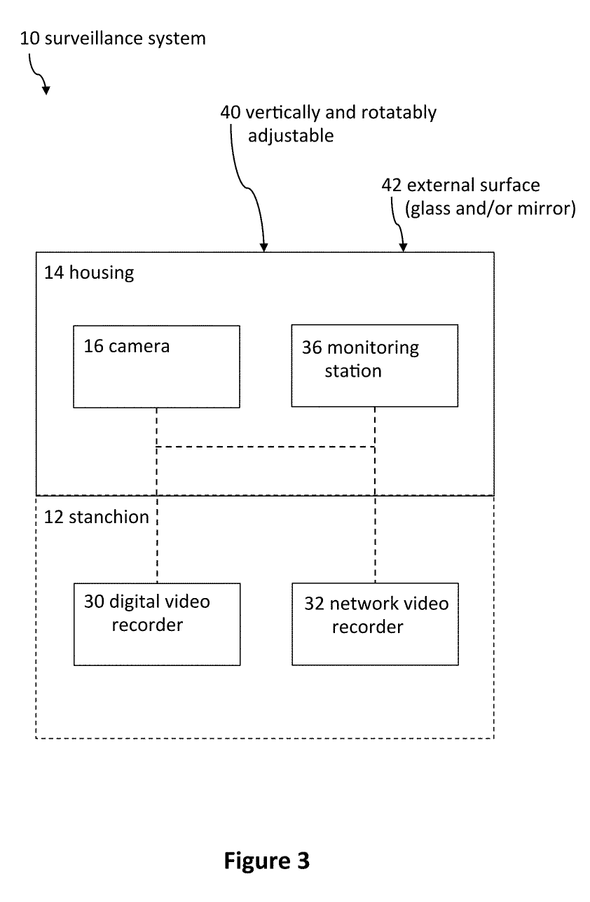

With reference to FIG. 3, the system 10 can also include a monitoring station 36 communicatively coupled to the camera 16 and at least one of the digital video recorder 30 and the network video recorder 32. It should be appreciated that the monitoring station 36 can be arranged and configured to display an image captured by the camera 16. The monitoring station 36 can thereby include a television, computer screen, monitor, and the like. In some embodiments, the monitoring station 36 is located within the housing 14.

As further shown in FIG. 3, the housing 14 can include an external surface 42 comprising any variety of materials. In some embodiments, the external surface 42 comprises glass and/or a mirrored material to enable one-way visibility whereby passengers and travellers are able to be viewed from a person and/or camera behind the glass and/or mirror.

In some embodiments, the housing 14 is arranged and configured to be vertically and rotatably adjustable 40 with respect to the stanchion 12. In this manner, the housing 14 may rise, lower, and/or rotate with respect to the stanchion 12.

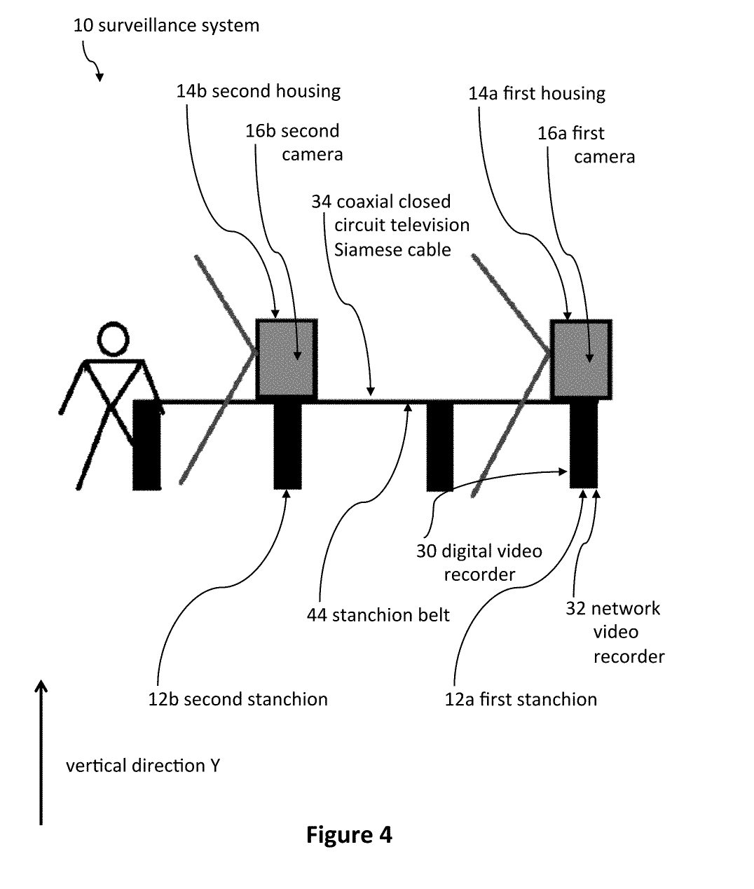

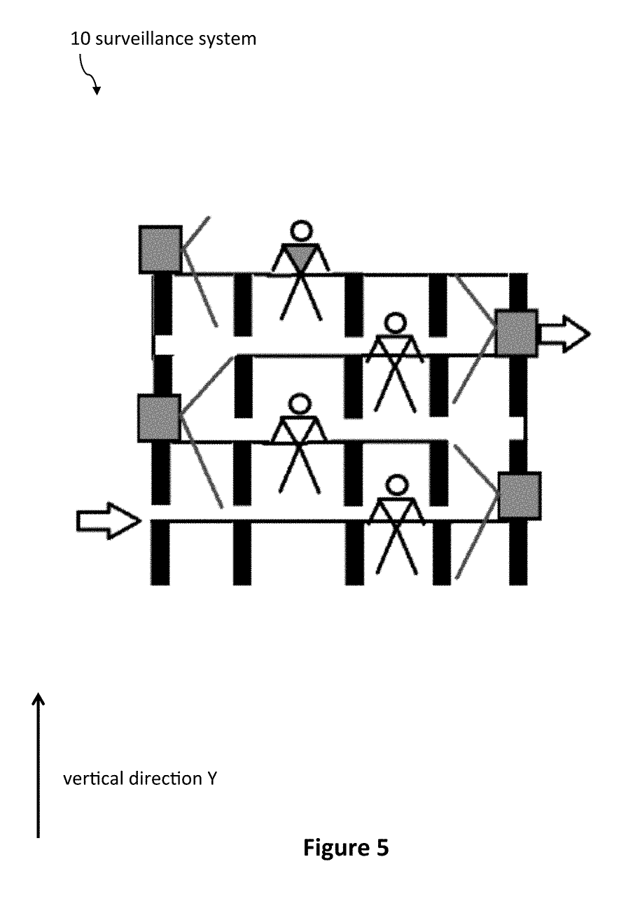

As illustrated in FIG. 4, the system 10 may include more than one stanchion, housing, and/or camera. For example, the system 10 may include a first stanchion 12a, a second stanchion 12b coupled to the first stanchion 12a by a stanchion belt 44, a first housing 14a, a second housing 14b, a first camera 16a, and a second camera 16b. The cameras 16a and 16b may be communicatively linked to each other.

Additionally, the system 10 may include at least one of a digital video recorder 30 and a network video recorder 32 communicatively coupled to both the first camera 16a and the second camera 16b. In some embodiments, at least one of the digital video recorder 30 and the network video recorder 32 are located within an internal portion of the first stanchion 12a and remotely located with respect to the second stanchion 12b.

In some embodiments, the first camera 16a, second camera 16b, and at least one of the digital video recorder 30 and the network video recorder 32 are communicatively and/or electrically coupled together via a coaxial closed circuit television Siamese cable 34. In such embodiments, the coaxial closed circuit television Siamese cable 34 may be at least partially located within the internal portion of the first housing 14a, the internal portion of the first stanchion 12a, the internal portion of the second housing 14b, an internal portion of the second stanchion 12b, and an internal portion of the stanchion belt 44. In this manner, the coaxial closed circuit television Siamese cable 34 may be substantially hidden from view.

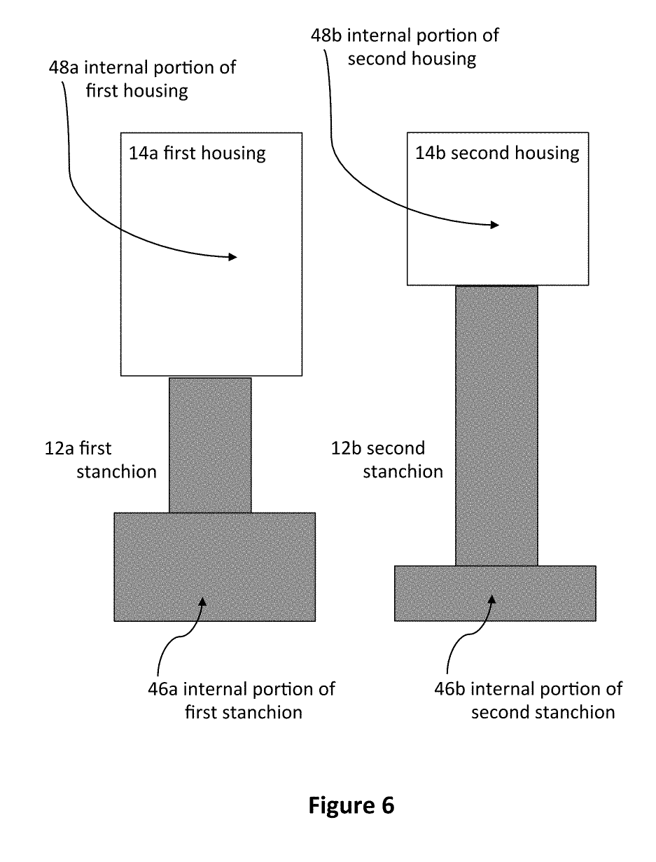

With respect to FIG. 6, the system 10 may include stanchions and/or housings that are sized differently from one another. For example, in some embodiments, the first stanchion 12a defines an internal portion 46a that is larger than the internal portion of the second stanchion 46b. Likewise, in some embodiments, the first housing 14a defines an internal portion 48a that is larger than the internal portion of the second housing 48b.

### Interpretation

The term “substantially” should be understood to mean to a great or significant extent, for the most part, essentially. “Substantially” should be interpretted to mean at least 51%.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A surveillance system, comprising:
a stanchion elongate along a vertical direction;
a housing coupled to an upper surface of the stanchion; and
a camera located within an internal portion of the housing, wherein the camera is arranged and configured to capture images of people located adjacent to the stanchion.

2. The system of claim 1, wherein the camera is visually hidden from the people located adjacent to the stanchion.

3. The system of claim 2, wherein the camera comprises a rechargeable camera.

4. The system of claim 3, further comprising a backup battery located within the internal portion of the housing, the backup battery configured to provide backup power to the rechargeable camera.

5. The system of claim 2, wherein the camera comprises an IP camera, the system comprising a power source configured to provide power to the IP camera.

6. The system of claim 5, further comprising a Power over Ethernet cable electrically coupled to the camera and the power source.

7. The system of claim 6, further comprising at least one of a digital video recorder and a network video recorder communicatively coupled to the camera and remotely located with respect to the camera.

8. The system of claim 7, wherein the at least one of the digital video recorder and the network video recorder are located within an internal portion of the stanchion.

9. The system of claim 8, further comprising a coaxial closed circuit television Siamese cable electrically coupled to the camera and at least one of the digital video recorder and the network video recorder.

10. The system of claim 9, wherein the coaxial closed circuit television Siamese cable is at least partially located within the internal portion of the housing and the internal portion of the stanchion such that the coaxial closed circuit television Siamese cable is substantially hidden from view.

11. The system of claim 10, further comprising a monitoring station communicatively coupled to the camera and at least one of the digital video recorder and the network video recorder, wherein the monitoring station is arranged and configured to display an image captured by the camera.

12. The system of claim 11, wherein the monitoring station is located within the housing.

13. The system of claim 12, wherein an external surface of the housing comprises at least one of glass and mirror.

14. The system of claim 2, wherein the housing is arranged and configured to be vertically and rotatably adjusted with respect to the stanchion.

15. The system of claim 2, wherein the stanchion is a first stanchion, the system comprising a second stanchion coupled to the first stanchion by a stanchion belt.

16. The system of claim 2, wherein the stanchion is a first stanchion, the housing is a first housing, and the camera is a first camera, the system comprising:
a second stanchion elongate along the vertical direction and coupled to the first stanchion by a stanchion belt;
a second housing coupled to an upper surface of the second stanchion; and
a second camera located within an internal portion of the second housing, wherein the second camera is arranged and configured to capture images of people located adjacent to the second stanchion.

17. The system of claim 16, further comprising at least one of a digital video recorder and a network video recorder communicatively coupled to both the first camera and the second camera, wherein the at least one of the digital video recorder and the network video recorder are located within an internal portion of the first stanchion and remotely located with respect to the second stanchion.

18. The system of claim 17, further comprising a coaxial closed circuit television Siamese cable electrically coupled to the first camera, the second camera, and at least one of the digital video recorder and the network video recorder.

19. The system of claim 18, wherein the coaxial closed circuit television Siamese cable is at least partially located within the internal portion of the first housing, the internal portion of the first stanchion, the internal portion of the second housing, an internal portion of the second stanchion, and an internal portion of the stanchion belt such that the coaxial closed circuit television Siamese cable is substantially hidden from view.

20. The system of claim 19, wherein the internal portion of the first stanchion is larger than the internal portion of the second stanchion.
